(19) United States
(12) Patent Application Publication
(10) Pub. No.: US 2025/0163304 A1
(43) Pub. Date: May 22, 2025

(54) LIQUID PASTE FOR PAPER

(71) Applicant: KOKUYO CO., LTD., Osaka (JP)

(72) Inventor: Manari Shigeno, Osaka (JP)

(21) Appl. No.: 18/839,662

(22) PCT Filed: Feb. 17, 2023
(86) PCT No.: PCT/JP2023/005689

§ 371 Date: Aug. 19, 2024

(30) Foreign Application Priority Data
Feb. 17, 2022 (JP) 2022-022734

(51) Int. Cl. C09J 103/02; C09J 101/08; C09J 103/04

(52) U.S. Cl. CPC C09J 103/02; C09J 101/08; C09J 103/04

(57) ABSTRACT

Problem: It is to provide a liquid glue for paper, which is able to meet more diverse usages and needs, by using ingredients and compositions different from conventional ones, and to especially provide a liquid glue that hardly causes wrinkles in paper sheets.

Solution: In a preferred embodiment, the solid content (nonvolatile content) excluding water is 40 to 70% by weight; and the solid content part is substantially composed of a water-soluble modified polysaccharide and a low molecular weight saccharide; weight ratio of low molecular saccharide to modified polysaccharide (weight of low molecular saccharide÷weight of modified polysaccharide) is from 0.4 to 12; and viscosity (BL type viscometer, 6 rpm) of the liquid glue is 700 to 8000 mPa/s. In particularly preferred embodiments, the water-soluble modified polysaccharide is a hydroxyalkylated starch, other modified starch, or dextrin; and the low molecular weight saccharide is a monosaccharide or disaccharides, such as sucrose, fructose, glucose, xylose, maltose, trehalose or the like, xylitol, sorbitol or oligosaccharides.

### TECHNICAL FIELD

The present invention relates to a liquid glue being used for bonding paper sheets together. In particular, the invention relates to a liquid glue, which is used for bonding together sheets of office paper such as printer paper, office envelopes or the like, or for bonding such sheet on other sheet of paper or cloth, and has the property of being difficult to cause wrinkles.

### BACKGROUND TECHNOLOGY

In recent years, liquid glue or solid glue (stick glue, tape glue) has been mainly used as office glue instead of traditional starch glue in paste form. Liquid glue is usually placed in a colorless, transparent, flexible tube-shaped container, and is discharged through a “sponge” or porous sheet at the tip of the container so as to be applied to paper or the like. Almost all commercially available liquid glues are composed of viscous aqueous solutions of polyvinyl alcohol (PVA).

Liquid glue has the advantage of being easier to apply over a larger area more quickly than the stick glue, and is able to achieve stronger adhesion, after drying for a while, than the stick glue. There has been a problem, however, the liquid glue may occasionally cause wrinkles.

Recently, “wrinkle-free glue” (Fuekinori Kogyo Co., Ltd.) whose main component is polysaccharide has been commercially available (Non-Patent Document 1).

On the other hand, modified starches ((chemically) modified starches) such as hydroxyalkylated starches have been occasionally used as food additives (Non-Patent Documents 2 to 3). Hydroxyalkylated starch has been occasionally used in production of pharmaceutical preparations, and has also been proposed to be added to detergents (Patent Document 1).

### PRIOR ART DOCUMENTS

### Patent Documents

[Patent Document 1] JP 2017-210458 “Detergent composition containing hydroxyalkylated starch”

### Non-Patent Documents

[Non-Patent Document 1] “Wrinkle-free glue” (Fueki Nori Kogyo Co., Ltd.) https://www.fueki.co.jp/products/stationery/liquid_P4.php
[Non-Patent Document 2] HYDROXYPROPYL STARCH, International Program on Chemical Safety (IPCS) https://inchem.org/documents/jecfa/jecmono/v17je18.htm
[Non-patent document 3] “Basic knowledge and current situation of processed starch”, Independent Administrative Agency, Japan Agriculture and Livestock Industry Promotion Agency https://www.alic.go.jp/joho-d/joho07_000055.html

### DISCLOSURE OF THE INVENTION

### Problem to be Solved by the Invention

According to present invention, it is aimed to provide a liquid glue for paper that is able to meet more diverse usages and needs, by using ingredients and compositions different from conventional ones, and to especially provide a liquid glue, by which wrinkles hardly occur.

### Means to Solve the Problem

In a preferred embodiment, the liquid glue for paper has a solid content (nonvolatile content) excluding water, of 35 to 70 wt % (percent by weight), preferably of 40 to 70 wt %, and the solid content (part) is substantially composed of: water-soluble modified polysaccharides (encompassing water-soluble starch derivatives, cellulose derivatives, and dextrins) and low-molecular saccharides (monosaccharides to tetrasaccharides, or molecular weights of 1000 or less or 800 or less). The weight ratio of the low molecular weight saccharide to the modified polysaccharides is 0.7 to 8 or 0.9 to 6, more preferably 1 to 4 or 1 to 3; and the liquid glue has a viscosity (BL type viscometer, 6 rpm) of 500 to 10,000 mPa/s, preferably of 700 to 8,000 mPa/s, more preferably of 1000 to 7000 mPa/s.

Here, “substantially” means that, for example, 90 wt % or more, or 95 wt % or more, of the solid content (part) is composed of these two types of compound species. In addition, “water-soluble” encompasses occasions where a stable dispersion is formed even if a complete aqueous solution is not formed, and preferably means that: a transparent glue liquid is formed and the transparent state is maintained even after storage for 3 months, for example.

The water-soluble modified polysaccharide is a compound species with a molecular weight of at least 800 or over 1000, preferably 2000 or more or 3000 or more, which is generally adoptable as a “thickener” (viscosity improver). The water-soluble starch derivatives have water solubility imparted or increased by etherification, oxidation, partial esterification, or the like. Preferred water-soluble starch derivatives may encompass water-soluble ones among chemically modified starches (Non-Patent Document 3).

In a preferred embodiment, the water-soluble starch derivative is nonionic (does not contain acid salts, phosphate groups, or the like), and is particularly hydroxyalkylated starch, oxidized starch, and the like. The hydroxyalkylated starch is preferably a hydroxypropylated starch (hydroxypropyl starch), but may also be a hydroxyethylated starch, a hydroxybutylated starch, or a combination of multiple types of hydroxyalkylated starches. The molar substitution degree (MS: number of moles of bound alkylene oxide per anhydroglucose unit) of the hydroxyalkylated starch is from 0.04 to 0.4, preferably from 0.05 to 0.35, more preferably from 0.08 and 0.25. Moreover, the hydroxyalkylation in the present application may involve introducing a methyl group, an ethyl group, or the like, together with a hydroxyalkyl group, such as in hydroxypropyl methylated starch. Further, the hydroxyalkylation may be combined with oxidation or the like, to introduce a carboxyl group.

As the water-soluble etherified starch, methylated starch is adoptable, but carboxymethylated starch (sodium starch glycolate), or the like may also be adopted. Their degree of etherification (degree of substitution) may preferably be, for example, from 0.04 to 0.4, from 0.05 to 0.35, or from 0.08 to 0.25. Further, the water-soluble cellulose derivative may be a water-soluble cellulose ether such as carboxymethyl cellulose, methyl cellulose, hydroxyethyl cellulose, or hydroxypropyl methyl cellulose. The degree of etherification (degree of substitution) here may be, for example, from 0.3 to 1.7 or from 0.4 to 1.5. Here, such etherified starches or starch derivatives may be combinedly subjected to a treatment such as introduction of carboxyl groups by oxidation, as needed.

Hydroxyalkylated starches, other modified starches or starch derivatives, or cellulose derivatives may be subjected to treatment to reduce the molecular weight of polysaccharide glycan chains (or to lower viscosity), or may not be subjected to such treatment (so that the molecular weight may be one million or more, for example). Namely, the molecular weight (weight average molecular weight by SEC) may be modified properly as appropriate or needed, through hydrolysis treatment by applying enzymes, oxidizing agents, acids, or heat, to a range from 10,000 to 700,000, preferably from 50,000 to 450,000, and more preferably from 70,000 to 300,000 or from 80,000 to 250,000. The hydrolysis treatment may preferably be carried out after the hydroxyalkylation, but may also be carried out before the hydroxyalkylation. The molecular weight may be measured by, for example: adopting as an eluent, a DMSO/DMF (75/25) solvent to which LiBr has been added; and using samples heated and dissolved in DMSO (https://www.shodex.com/ja/dc/Mar. 6, 2002.html). Moreover, viscosity of aqueous solution of the hydroxyalkylated starch (30% water content, 30° C., 60 rpm) may be 50 to 1000 mPa·s or 70 to 600 mPa·s. Moreover, the water content in the hydroxyalkylated starch or other modified starch may be about 5-7% by weight.

Waxy corn starch and waxy potato starch are particularly preferably used as raw-material starch(s) for hydroxyalkylated starch, other (chemically) processed starches, or starch derivatives. That is, those with a low amylose content (high degree of branching) and easy gelatinization are preferred. However, in some occasions, regular (non-waxy) potato starch or tapioca starch may also be used.

In this patent application, water-soluble “(chemically) modified starch” or starch derivatives and “starch” encompass various dextrins. Moreover, as the water-soluble modified polysaccharide or the base polysaccharide thereof, α-glucans such as dextran as well as other nonionic thickening polysaccharides may be adopted in some occasions.

If viscosity of the liquid glue is insufficient, such as when using one having a relatively low molecular weight, the liquid glue may be added with a polysaccharide thickener such as guar gum, gum arabic, xanthan gum, or pullulan, especially with a nonionic polysaccharide thickener. In this way, a resultant mixture or combination, or the “(chemically) modified starch” or a starch derivative added with the polysaccharide thickener, may be controlled to have a viscosity of an aqueous solution (30% aqueous solution on basis of hydrated-state or hydrous-state saccharide material, 30° C., 60 rpm) in a range of 50 to 1000 mPa·s or 70 to 600 mPa.

The liquid glue for paper of the present invention, in one particularly preferred embodiment, is essentially composed of: hydroxypropylated starch (including hydroxypropylated starch hydrolysates, such as hydroxypropylated dextrins) or other modified starches (or other modified polysaccharides) in a range of 4-45% by weight or 4-40% by weight (especially 15-30% by weight or 20-25% by weight); sucrose or other low molecular saccharides in a range of 15-60% by weight or 15-55% by weight (especially 25-45% or 30-45% by weight); and water in a range of 30-65% by weight or 30-60% by weight (especially 35-47% by weight or 35-45% by weight).

### Advantageous Effect of the Invention

The liquid glue has an appropriate viscosity during use, has sufficient adhesive strength after pasting, and is, in same time, able to suppress causing of wrinkles.

### EMBODIMENT

Preferred embodiments of the liquid glue for paper of the present invention will be described below, but the present invention encompasses those having portion(s) replaced with equivalents or equivalent configurations and having equivalent effects.

The liquid glue for paper may have a solid content (nonvolatile content) excluding water, in a range of 30 to 72%, more preferably 35 to 70% or 40 to 65%. More specifically, upper limit of solids content may be 72%, 71%, 70%, 69%, 68%, 67%, 66% or 65%. Meanwhile, lower limit of solids content may be 42%, 41%, 40%, 39%, 38%, 37%, 36% or 35%. Moreover, in some cases, the lower limit of solids content may be 34%, 32% or 30%. Further, 90% or more, 93% or more, 95% or more, or 98% or more of the solid content (part) is composed of: modified (chemically processed) starch (encompassing dextrin) and low molecular weight saccharides.

The range of the solid content may vary depending on types of low molecular weight saccharide described below, particularly depending on solubilities in water at room temperature (for example, 20° C., 25° C. or 30° C.). For example, sucrose (211.5 g/100 g water) and fructose (388 g/100 g water), which have high solubility at 20° C., may be used in ranges wider than those described above, or in some cases in a slightly wider range than the above. However, when using low-molecular-weight saccharides that have lower solubility at 20° C. than sucrose, such as maltose (101 g/100 g water), glucose (88 g/100 g water) or the like for example, then preferred range of the solid content may be narrower than the above, in particular the upper limit of the preferred range may be lower than the above. For example, when using maltose, glucose, or the like, the upper limit of the preferred range of solid content may be less than 70% by weight, and be 69%, 68%, 67%, 66%, 65%, 64%, 63%, 62%, 61%, or 60%. On the other hand, when using trehalose (69 g/100 g water), which has a lower solubility at 20° C., the upper limits of the solid content may be same as those of glucose or the like, or may be even lower. For example, such upper limit of the preferred range of solids content may be 64%, 63%, 62%, 61%, 60%, 59%, 58%, 57%, 56% or 55%.

The weight ratio of low-molecular-weight saccharide to water-soluble modified polysaccharide (weight of [low-molecular-weight saccharide]÷weight of [modified polysaccharide]) may be a weight ratio of compound species between those having a molecular weight of 1000 or more and those having a molecular weight of less than 1000, for example. For example, when using a certain type of dextrin or powdered starch syrup, the saccharides may be divided into a part that belongs to the modified polysaccharide and a part that belongs to the low molecular weight saccharide, depending on whether the molecular weight is 1000 or less, or not. Additionally, when those having low molecular weights is used as the modified polysaccharide, such as those having weight average molecular weight (e.g., in terms of glucose by GPC using a DMSO aqueous solution) at 20,000 or less or 10,000 or less, the weight ratio of the low molecular saccharides to the modified polysaccharides may be, for example, 0.4-3 or 0.5-2. Conversely, when those having a high molecular weight is used as the modified polysaccharide, such as those having a weight average molecular weight of 500,000 or more or 1,000,000 or more, the weight ratio of the low-molecular-weight saccharide to the modified polysaccharide may be adjusted to a range of: 4 to 12, 4 to 8, or 4 to10, for example.

As the low-molecular-weight saccharide, saccharide alcohols, which are directly derivable from monosaccharides or disaccharides, may be used; and the solid content may be set to be same or similar range with the above even with the saccharide alcohols. For xylitol (50 g/100 g water), which is a saccharide alcohol with five carbon atoms, adoptable solid content range may be same or similar with those of glucose or the like as mentioned above. Further, for sorbitol (solubility: 220 g/100 g water), which is a saccharide alcohol with six carbon atoms, adoptable solid content ranges may be same or similar with those of sucrose as mentioned above.

Various oligosaccharides may be used as the low-molecular-weight saccharides or materials containing such low-molecular-weight saccharides. Examples of the oligosaccharides include: raffinose, maltotriose, galactooligosaccharide, fructooligosaccharide, and lactosucrose, and the like. In some cases, starch syrup or high maltose syrup having a DE (Dextrose Equivalent) value of 40 or more or 45 or more may be used.

The water-soluble modified polysaccharide may be etherified starch, oxidized starch, etherified cellulose, oxidized starch, or the like, and may also be etherified oxidized starch, esterified oxidized starch, or the like Further, dextrin may be adopted, and etherified or oxidized dextrin may be adopted. Etherification here encompasses hydroxypropylation, hydroxyethylation, methylation, carboxymethylation, and the like. The water-soluble modified polysaccharides encompass water-soluble ones that are generally referred to as modified starches (Non-Patent Document 3).

In addition to hydroxyalkylated starches, the (chemically) modified starches encompass: oxidized starches, oxidized acetylated starches, and the like; as well as various dextrins and equivalent thickening polysaccharides or their hydrolysates; and “processed” ones thereof, which means those that have undergone “processing” such as alkylation, are hydroxyalkylated starches or the like. Particularly, the water-soluble modified polysaccharides may be non-ionic ones (those containing no acid salts or phosphate groups) among those commonly referred to as the (chemically) modified starches (Non-Patent Document 3). Depending on circumstances, however, the (chemically) modified starch may be acetyl (acetylated) starch, or may be partially crosslinked dextran.

The “hydroxyalkylation” in this patent application is exactly the same as explained for the above-mentioned hydroxypropylated starch. That is, hydroxypropylation, hydroxypropyl methylation, hydroxyethylation, or the like are included. Furthermore, instead of the “hydroxyalkylation”, etherification such as methylation or carboxylic-acid esterification such as acetylation may be adopted. The oxidized starch means one having carboxyl groups as introduced through oxidation by using sodium hypochlorite or the like. Here, the degree of etherification such as “hydroxyalkylation” or methylation may be, for example, 3 to 10% or 4 to 8% in terms of molar ratio with respect to hydroxyl group of the saccharide. Further, the degree of carboxylic-acid esterification such as acetylation may be, for example, 0.3 to 3%, 0.3 to 2%, 1 to 5%, or 1 to 4% in terms of molar ratio with respect to hydroxyl groups of the saccharide Furthermore, as for the oxidized starch, the ratio of carboxyl groups introduced by oxidation treatment, to hydroxyl groups in the “starch” before oxidation treatment, may be 0.5 to 10%, 0.5 to 2%, 0.5 to 3%, 1 to 4% or 1 to 7%.

Typically, there have been used hydroxyalkylated starchs having molar substitution degrees (MS) of 0.04 to 0.4, and their safety has been confirmed (Non-Patent Document 2). The hydroxyalkylated starch may be produced as described in the Examples of Patent Document 1 as in the following: a relatively small amount of sodium sulfate aqueous solution is added to sodium hydroxide; into such mixture solution, starch is added so as to be reacted; and then subjected to neutralization, washing with water, dehydrating, drying, and pulverizing, and then to reducing of the molecular weight to an appropriate level. In addition to using an enzyme, the molecular weight reduction may be performed using an oxidizing agent such as sodium hypochlorite or hydrogen peroxide. According to Table 1-1 of Patent Document 1, the amylose content of waxy starch is less than 1%, and the amylose contents of general potato starch and tapioca starch are around 20%.

By using an appropriate amount of hydroxyalkylated starch or other modified starch having an appropriate molecular weight or an appropriate viscosity range (30% viscosity), it is able to impart to the liquid glue, an appropriate viscosity, tackiness immediately after pasting as well as adhesive properties after solidification (being dried out). Meanwhile, by adopting saccharide compounds with low molecular weight (molecular weight less than 1000, less than 800, or less than 600), such as sucrose, it is believed to enable not only lowering of moisture content of the glue, but also imparting suitable fluidity to a layer of the glue after pasting, in combination with the hydroxyalkylated starch or other modified starch so as to achieve a property of hardly causing wrinkles.

In a particularly preferred embodiment, the processed starch is hydroxypropylated starch that are currently used as additive for food or medicine (which has a molar substitution degree of 0.04 to 0.4, a molecular weight of 50,000 to 450,000 and viscosity of 50 to 1000 mPa·s for 30%-aqueous solution) is preferable because the hydroxypropylated starch exhibits viscosity characteristics similar to gum arabic, has excellent film-forming properties, and forms a transparent and uniform adhesive layer.

As the dextrin, adoptable is one with a DE (Dextrose Equivalent) value of 10 or less and a polymerization degree of 12 or more; and also adoptable is maltodextrin (DE of about 10 to 20, polymerization degree of 6 to 10). In some cases, one called powdered starch syrup may also be used as a material containing the water-soluble modified polysaccharide (having molecular weight over 1000).

The low molecular weight saccharide is a monosaccharide, a disaccharide, or a saccharide alcohol thereof; and in some cases, a trisaccharide, a tetrasaccharide, or an oligosaccharide is adoptable. As monosaccharides or disaccharides, preferred ones are sucrose and fructose, which have high solubility in water while glucose, xylitol, and saccharide compounds having similar solubility to these may also be used in almost the same way. For example, xylose, maltose, trehalose, lactose, raffinose, maltotriose, or the like may also be used. Furthermore, saccharide alcohols having at least four carbon atoms, particularly five or more carbon atoms, may be used. Specifically, sorbitol, xylitol, or the like may be used. In some cases, various oligosaccharides (particularly trisaccharides or tetrasaccharides) may also be used, alone or in combination with monosaccharides or disaccharides. The oigosaccharides usually have a number average molecular weight of 1000 or less, 800 or less, or 600 or less.

Sucrose is particularly preferred among low molecular weight saccharide compounds because it is inexpensive and may be made into a highly concentrated aqueous solution. Maltose and the like, however, may also be used in place of or in combination with sucrose. To prepare a liquid glue, for example, a highly concentrated (e.g., 53-57% by weight) aqueous solution of hydroxyalkylated starch may be mixed with a highly concentrated (e.g., 57-63% by weight) aqueous solution of sucrose.

The liquid glue, in a preferred embodiment, is essentially composed of: hydroxyalkylated starch or other modified starch (in some case, the modified starch and the other thickening polysaccharides); the low-molecular weight saccharide compounds such as sucrose; and water, and thus remainder other than the modified starch and the low-molecular weight saccharide compounds is essentially composed of water. The liquid glue may contain, however, starch or its hydrolyzate, salts such as pH adjusters, preservatives such as polyamino acids, or the like, as added as needed or appropriately. If being contained, added amount of these may be, for example, 10% or less, 7% or less, 5% or less or 3% by weight, of the liquid glue.

Here, the polysaccharide thickener other than the “modified starch” is to improve wrinkle-free property (property of hardly causing wrinkles) or tackiness by making the viscosity in a more preferred range when the solid content is low (for example, 30 to 45% by weight, 30 to 43% by weight, or 30 to 40% by weight). As the polysaccharide thickener, nonionic ones (excluding alginic acid or the like) may be particularly preferably used; and for example, xanthan gum, guar gum, locust bean gum, carrageenan, gum arabic, or the like may be used. In some cases, methylcellulose or the like may also be used. The content of polysaccharide thickener in the liquid glue may be, for example, 0.1 to 5%.

### <Liquid Glue and Viscosity of Examples, Reference Examples, and Comparative Examples>

The following reference examples are not meant to be outside the scope of the present invention, but might become rendered as Examples.

### (1) Processed Starch

The processed starches used are all hydrated (hydrous) ones having a water content of about 6 to 7%.

### (1-1) Hydroxypropylated Starch 1-3

In most experiments, Hydroxypropylated starch 1 as mentioned below was used. Meanwhile, in a very few number of experiments, Hydroxypropylated starches 2 and 3 were used. Hydroxypropylated starches 1 and 2 were obtained by hydroxypropylating starch and then hydrolyzing it by enzymatic treatment. The molecular weight here means a weight average molecular weight.

TABLE 1

| | Hydroxypropylated | Hydroxypropylated | Hydroxypropylated |
|---|---|---|---|
| | starch 1 | starch 2 | starch 3 |
| Generic name | Hydroxypropylated starch hydrolysate | | |
| Ingredients | Waxy starch (corn starch or potato starch) | | |
| Molar substitution | approximately 0.15 | | |
| degree | | | |
| Branching degree | No data | | |
| Viscosity | 150-300 cps (mPa · s) | 2 to 4 cps (mPa · s) | 20 to 100 cps (mPa · s) |
| | (30% (hydrous state- | (10% (hydrous state- | (15% (hydrous state- |
| | basis) aqueous | basis) aqueous | basis) aqueous |
| | solution, 30° C., 60 rpm) | solution, 25° C., 30 rpm) | solution, 25° C., 30 rpm) |
| Molecular weight | 140,000 to 150,000 | 1 to 20,000 | million or more |

### (1-2) Tapioca Maltodextrin 1-2

Used were those derived from tapioca starch having a DE value of 18 (Tapioca maltodextrin 1) and from tapioca starch having a DE value of 25 (Tapioca maltodextrin 2).

### (1-3) Oxidized Acetylated Starch 1-2

Tapioca starch (amylose content is approximately 17%) was used as a raw material; and oxidative modification was made to such raw material so as to be rendered to have a viscosity of 20% (Dry; absolute-dry weight basis) aqueous solution in a range of 60 to 80 cps (mPa s). Adopted were: those having a degree of acetyl substitution of 0.02 or more (Oxidized acetylated starch 1); and those having a degree of acetyl substitution of 0.012 or more (Oxidized acetylated starch 2). Namely, about 1.3% or more and about 0.4% or more of the hydroxyl groups of the respective starches were converted to acetyl groups.

### (2) Low Molecular Saccharides

Sucrose (SU) (purity of 99.5% or higher) was used in most of the experiments. Moreover, adopted in place of sucrose, were: glucose as a monosaccharide compound, xylitol (five carbon atoms) as a saccharide alcohol, trehalose as a disaccharide compound, and galactooligosaccharide (4′-galactosyl lactose) as a trisaccharide compound. Each of these had purity of 99.5% or higher.

### (3) Preparation of Liquid Glues (I)

### (3-1) Examples 1 to 8

Liquid glues were prepared by mixing 55 wt % aqueous solution of the above Hydroxypropylated starch 1 (HPS), with 60 wt % aqueous solution of sucrose (SU), at a ratio of 1:1 to 1:7. Further, liquid glues were prepared also by mixing respective one of 45 wt % and 50 wt % aqueous solutions of the above Hydroxypropylated starch 1 (HPS), with 60 wt % aqueous solution of sucrose, at a ratio of 1:1. These are summarized in Table 2 below.

TABLE 2

| | | Weight | | Solid | | | | |
|---|---|---|---|---|---|---|---|---|
| | | composition (%) | | content | 60 rpm | 30 rpm | 12 rpm | 6 rpm |
| | | HPS:SU:Water | SU/HPS | (%) | Viscosity | Viscosity | Viscosity | Viscosity |
| Example 1 | 45% HPS + 60% | 22.5:30:47.5 | 1.33 | 52.5 | 1550 | 1600 | 1500 | 1500 |
| | SU 1:1 | | | | | | | |
| Example 2 | 50% HPS + 60% | 25:30:45 | 1.20 | 55 | 1900 | 1900 | 2000 | 2000 |
| | SU 1:1 | | | | | | | |
| Example 3 | 55% HPS + 60% | 27.5:30:42.5 | 1.09 | 57.5 | | | | |
| | SU 1:1 | | | | | | | |
| Example 4 | 55% HPS + 60% | 22:36:42 | 1.64 | 58 | | | | |
| | SU 2:3 | | | | | | | |
| Example 5 | 55% HPS + 60% | 18.1:40.2:41.7 | 2.21 | 58.4 | 4250 | 4200 | 4250 | 4500 |
| | SU 1:2 | | | | | | | |
| Example 6 | 55% HPS + 60% | 13.7:45:41.3 | 3.27 | 58.8 | 800 | 800 | 750 | 1000 |
| | SU 1:3 | | | | | | | |
| Example 7 | 55% HPS + 60% | 11:48:41 | 4.36 | 59 | 750 | 800 | 750 | 1000 |
| | SU 1:4 | | | | | | | |
| Example 8 | 55% HPS + 60% | 6.9:52.5:40.6 | 7.64 | 59.4 | 350 | 400 | 500 | 1000 |
| | SU 1:7 | | | | | | | |
| Comparative | Arabic Yamato | PVA aqueous | | | 4800 | 4800 | 5000 | 5000 |
| example 1 | | solution | | | | | | |
| Comparative | “Wrinkle-free | Polysaccharide | | | 4500 | 4800 | 5250 | 6000 |
| example2 | glue” | | | | | | | |

### (3-2) Viscosity Measurement

By using a BL type viscometer (TOKI SANGYO BL II), rotational viscosities of the liquid glues were measured using a Rotor No. 4 at 25° C. For measurement, the liquid glues were placed in vials (Maruemu container No. 7:14 mL, φ21.0×φ21.4×55.5 (mm)) so that the liquid level reaches 6 cm height, and kept in a constant-temperature water bath for at least 30 minutes. Then, the Rotor was placed in the liquid; numerical value was read 30 seconds after starting of rotation; and converted value (mPa/s) was obtained. Moreover, in this way, measurements were made continuously in the order of 60 rpm→30 rpm→12 rpm→6 rpm. The results are shown in Table 2.

According to results in Table 2, as for Examples 1 to 5, the rotational speed dependence (shear-rate dependence; thixotropy) of viscosity was small as in Comparative Examples 1 to 2, which are conventional products. On the other hand, as for Example 8, the rotation speed dependence of the viscosity was large. However, the viscosity at low rotational speeds is not so small.

### (3-3) Comparative Example 1

As for Comparative Example 1, “Arabic Yamato Standard” (Yamato Co., Ltd.) was used, which is one of the typical commercially available liquid glues. This liquid glue, like most other commercially available liquid glues, is comprised of a viscous aqueous solution of polyvinyl alcohol (PVA).

### (3-4) Comparative Example 2

As for Comparative Example 2, the above-mentioned “Wrinkle-Free Glue” (Fueki Nori Kogyo Co., Ltd.) was used. This liquid glue comprises, as its main component, (aqueous-type) polysaccharide and has a water content of about 30 wt %.

(4) Preparation of liquid glues (II) (Examples 9 to 26 and Reference Examples 1 to 5) As for Examples 9 to 15 below, liquid glues were prepared by mixing the aqueous solution of Hydroxypropylated starch 1 (HPS) with 60 wt % aqueous solution of sucrose (SU) in a manner shown in Table 4 below.

TABLE 3

| | | Weight composition | | Solid |
|---|---|---|---|---|
| | | (%) HPS:SU:Water | SU/HPS | content (%) |
| Example 9 | 40% HPS + 60% SU 2:1 | 26.8:19.8:53.4 | 0.74 | 47 |
| Example 10 | 50% HPS + 60% SU 2:3 | 20:36:44 | 1.8 | 56 |
| Example 11 | 60% HPS + 60% SU 1:4 | 12:48:40 | 4.0 | 60 |
| Example 12 | 58% HPS + 60% SU 1:2 | 19:40:41 | 2.1 | 59 |
| Example 13 | 58% HPS + 60% SU 1:3 | 14.5:45:40.5 | 3.1 | 59.5 |
| Example 14 | 60% HPS + 60% SU 1:2 | 20:40:40 | 2.0 | 60 |
| Example 15 | 60% HPS + 60% SU 1:3 | 15:45:40 | 3.0 | 60 |

As for Examples 16 to 26 shown in Table 6 and for Reference Examples 1 to 5 shown in Table 7, which are presented later, the liquid glues were prepared by mixing the aqueous solution of the above Hydroxypropylated starch 1 (HPS) with aqueous solution of sucrose (SU).

### (5) Preparation of Liquid Glues (III) (Examples 27-31, Reference Examples 9-12)

As for Examples 27 to 31 and Reference Examples 9 to 11 shown in Table 8, which is presented later, the liquid glues were prepared by mixing aqueous solution of the Hydroxypropylated starch 1 (HPS), with aqueous solution of each of various low molecular saccharides (LS) in place of sucrose (SU) so as to have a respective composition shown in left-end portion of the Table 8.

### (6) Preparation of Liquid Glues (IV) (Examples 32-33, Reference Examples 13-14)

As for Examples 32 to 36 and Reference Examples 13 to 14 shown in Table 9, which is presented later, the liquid glues were prepared by mixing each of various “processed starches” (PS), in place of Hydroxypropylated starch 1 (HPS), with the aqueous solution of low-molecular saccharide so as to have a respective composition shown in left-end portion of the Table 9.

### Performance Evaluation Method

### (1) Wrinkle Resistance (Characteristics Hard to Cause Wrinkles)

The Glue was uniformly applied to entire surface of a coating-use paper sheet by a bar coater No. 26 (reference film thickness when wet is 60 μm), and the coating-use paper sheet was pasted onto a base paper sheet. Extent of wrinkles was then determined through a sensory evaluation conducted by a plurality of panelists. Here, wrinkle evaluation was performed after the pasted set of sheets was left for one hour, that is, after the pasted set of sheets was dried until the moisture disappeared. Specifically, the evaluation was performed as follows.
Coating-use paper sheets: General-purpose white printer paper (A4 PPC, copy paper), basis weight 64 g/m², paper thickness 0.09 mm, KOKUYO's “KB39N”. The paper sheets were ones, each of which has been cut into a rectangle of 15×3 cm.
Base paper sheets: Campus notebook (Kokuyo's “Noh 3HAN”).
Sensory test: The test was commissioned to an external testing organization, and five panelists (men and women in their 30s to 40 s) evaluated the product using the following criteria. In some occasions, there occurred a one-level variation among panelists; then, the evaluation by the majority of panelists was adopted.
   ⊚ Almost no wrinkle is visible (no wrinkles or warping of the paper sheet is conceivable).
   ◯ Slight warping is visible by naked-eye observation, in an extent same as Comparative Example 2 (“Wrinkle-free glue”).
   ◯− Slightly inferior to Comparative Example 2, but significantly better than Comparative Example 1 (PVA aqueous solution).
   Δ Better than Comparative Example 1 (PVA aqueous solution), but wrinkles are visible by naked-eye observation.
   X Numerous wrinkles are visible.

### (2) Tackiness

The liquid glue was applied evenly onto entire flap of an envelope by using a cotton swab; then the flap was closed to be pasted onto the envelope proper. At that time, checking was made whether the flap part would be floated up, or not.
Envelope: General-purpose white envelope (“long size No. 3”, 120×235 mm), basis weight 100 g/m², paper thickness 0.10 mm.
   ⊚ The flap part would not be floated up.
   X The flap part being eventually floated up.

### (3) Stringiness

0.5 ml of the liquid glue was placed on an ABS resin board. Then, while a rubber board was repeatedly pressed onto and released from the resin board coated with the liquid glue, tendency of stringing of the liquid glue was observed and evaluated using the following criteria.
⊚ No stringiness is observed at all.
◯ Unless the pressing and releasing are repeated 5 times or more, stringiness is not observed.
X Stringiness is observed when the pressing and releasing are repeated 5 times or less.

### (4) Gelation Resistance

The liquid glue was placed in a 200 ml sample bottle and sealed off from outside, and then allowed to stand for 3 months, the presence or absence of cloudiness was evaluated as follows.
⊚ No clouding occurs and remains completely colorless and transparent.
◯ Slight cloudiness occurs, but no change in viscosity is observed.
X White turbidity occurs and viscosity increases by 10% or more.

### <Performance Evaluation Results>

The results of the performance evaluation related to the liquid glue preparation (I) (Table 2) are summarized in Table 4 below. As may be seen from Table 4 below, in Examples 2 to 8, satisfactory results were obtained in respect of wrinkle resistance, tackiness, transparency (storability), and stringiness. In particular, as for Example 4, although it did not appear in the evaluations in Table 4, the most excellent results were obtained in respect of the wrinkle resistance and the stringiness.

When the evaluation results of Examples 2 to 3 and 5 to 8 were compared with the evaluation results of Comparative Example 2, the wrinkle resistances were in same level. Nonetheless, in respect of the stringiness, the liquid glues of Examples were clearly superior to those of the Comparative Examples.

TABLE 4

| | Weight | | Solid | | | | |
|---|---|---|---|---|---|---|---|
| | composition (%) | | content | Wrinkle | | | Gel |
| | HPS:SU:Water | SU/HPS | (%) | resistance | Tackiness | Stringiness | resistance |
| Example 1 | 22.5:30:47.5 | 1.33 | 52.5 | ◯ | ⊚ | ⊚ | ⊚ |
| Example 2 | 25:30:45 | 1.20 | 55 | ⊚ | ⊚ | ⊚ | ⊚ |
| Example 3 | 27.5:30:42.5 | 1.09 | 57.5 | ⊚ | ⊚ | ⊚ | ⊚ |
| Example 4 | 22:36:42 | 1.64 | 58 | ⊚ | ⊚ | ⊚ | ⊚ |
| Example 5 | 18.1:40.2:41.7 | 2.21 | 58.4 | ⊚ | ⊚ | ◯ | ⊚ |
| Example 6 | 13.7:45:41.3 | 3.27 | 58.8 | ⊚ | ⊚ | ⊚ | ⊚ |
| Example 7 | 11:48:41 | 4.36 | 59 | ⊚ | ⊚ | ⊚ | ⊚ |
| Example 8 | 6.9:52.5:40.6 | 7.64 | 59.4 | ⊚ | ⊚ | ⊚ | ⊚ |
| Comparative | PVA aqueous | | | X | ⊚ | ⊚ | ⊚ |
| example 1 | solution | | | | | | |
| Comparative | Polysaccharide | | | ◯ | ⊚ | X | ⊚ |
| example 2 | | | | | | | |

TABLE 5

| | Weight | | Solid | | | |
|---|---|---|---|---|---|---|
| | composition (%) | | content | Wrinkle | | |
| | HPS:SU:Water | SU/HPS | (%) | resistance | Tackiness | Stringiness |
| Example 9 | 26.8:19.8:53.4 | 0.74 | 47 | ⊚ | ⊚ | ⊚ |
| Example 10 | 20:36:44 | 1.8 | 56 | ⊚ | ⊚ | ⊚ |
| Example 11 | 12:48:40 | 4.0 | 60 | ⊚ | ⊚ | ⊚ |
| Example 12 | 19:40:41 | 2.1 | 59 | ⊚ | ⊚ | ⊚ |
| Example 13 | 14.5:45:40.5 | 3.1 | 59.5 | ⊚ | ⊚ | ⊚ |
| Example 14 | 20:40:40 | 2.0 | 60 | ⊚ | ⊚ | ⊚ |
| Example 15 | 15:45:40 | 3.0 | 60 | ⊚ | ⊚ | ⊚ |

TABLE 6

| | Weight | | Solid | | | |
|---|---|---|---|---|---|---|
| | composition (%) | | content | Wrinkle | | |
| | HPS:SU:Water | SU/HPS | (%) | resistance | Tackiness | Stringiness |
| Example 16 | 19:43:38 | 2.2 | 62 | ⊚ | ⊚ | ⊚ |
| Example 17 | 19:42:39 | 2.2 | 61 | ⊚ | ⊚ | ⊚ |
| Example 18 | 10:60:30 | 6.0 | 70 | ⊚ | ⊚ | ⊚ |
| Example 19 | 11:32:57 | 2.9 | 43 | ⊚ | ⊚ | ⊚ |
| Example 20 | 37:19:44 | 0.51 | 56 | ⊚ | ⊚ | ⊚ |
| Example 21 | 40:20:40 | 0.50 | 60 | ⊚ | ⊚ | ⊚ |
| Example 22 | 33.4:16.6:50 | 0.50 | 50 | ⊚ | ⊚ | ⊚ |
| Example 23 | 3.8:41:55 | 10.8 | 45 | ⊚ | ⊚ | ⊚ |
| Example 24 | 4.2:46:50 | 10.9 | 50 | ⊚ | ⊚ | ⊚ |
| Example 25 | 4.6:50.4:45 | 10.96 | 55 | ⊚ | ⊚ | ⊚ |
| Example 26 | 5:55:40 | 11.0 | 60 | ⊚ | ⊚ | ⊚ |

TABLE 7

| | Weight | | Solid | | | |
|---|---|---|---|---|---|---|
| | composition (%) | | content | Wrinkle | | |
| | HPS:SU:Water | SU/HPS | (%) | resistance | Tackiness | Stringiness |
| Reference | 18:52:30 | 2.9 | 70 | ⊚ | ⊚ | Δ |
| example 1 | | | | | | |
| Reference | 18:50:32 | 2.8 | 68 | ⊚ | ⊚ | ◯ |
| example 2 | | | | | | |
| Reference | 10:30:60 | 3.0 | 40 | ◯- | ⊚ | ⊚ |
| example 3 | | | | | | |
| Reference | 30:15:55 | 0.50 | 45 | ◯- | ⊚ | ⊚ |
| example 4 | | | | | | |
| Reference | 3.3:37:60 | 11.1 | 40 | ⊚ | ◯ | ⊚ |
| example 5 | | | | | | |

TABLE 8

| | | Weight | | Solid | | | |
|---|---|---|---|---|---|---|---|
| | | composition (%) | | content | Wrinkle | | |
| | | HPS:SU:Water | SU/HPS | (%) | resistance | Tackiness | Stringiness |
| Example 27 | Glucose | 30:23:47 | 0.77 | 53 | ⊚ | ⊚ | ⊚ |
| Example 28 | Glucose | 20:32:48 | 1.60 | 52 | ⊚ | ⊚ | ⊚ |
| Example 29 | Trehalose | 20:32:48 | 1.60 | 52 | ⊚ | ⊚ | ⊚ |
| Example 30 | Galacto- | 16:46:38 | 2.9 | 62 | ⊚ | ⊚ | ⊚ |
| | oligosaccharide | | | | | | |
| Example 31 | Xylitol | 10:50:40 | 5.0 | 60 | ⊚ | ⊚ | ⊚ |
| Reference | Glucose | 38:19:43 | 0.5 | 57 | ◯- | ⊚ | ⊚ |
| example 9 | | | | | | | |
| Reference | Trehalose | 30:21:49 | 0.7 | 51 | ◯- | ⊚ | ⊚ |
| example 10 | | | | | | | |
| Reference | Trehalose | 8:35:57 | 4.4 | 43 | ◯- | ⊚ | ⊚ |
| example 11 | | | | | | | |
| Reference | Galacto- | 16:36:48 | 2.25 | 52 | ◯- | ⊚ | ⊚ |
| example 12 | oligosaccharide | | | | | | |

TABLE 9

| | | Weight | | Solid | | | |
|---|---|---|---|---|---|---|---|
| | | composition (%) | | content | Wrinkle | | |
| | | HPS:SU:Water | SU/HPS | (%) | resistance | Tackiness | Stringiness |
| Example 32 | Tapioca | 20:40:40 | 2.0 | 60 | ⊚ | ⊚ | ⊚ |
| | maltodextrin 1 | | | | | | |
| Example 33 | Tapioca | 20:40:40 | 2.0 | 60 | ⊚ | ⊚ | ⊚ |
| | maltodextrin 2 | | | | | | |
| Example 34 | Hydroxypropylated | 30:30:40 | 1.0 | 60 | ⊚ | ⊚ | ⊚ |
| | starch 2 | | | | | | |
| Example 35 | Hydroxypropylated | 10:54:36 | 5.4 | 64 | ⊚ | ⊚ | ⊚ |
| | starch 3 | | | | | | |
| Example 36 | Hydroxypropylated | 8:50:42 | 6.25 | 58 | ◯ | ⊚ | ⊚ |
| | starch 3 | | | | | | |
| Reference | Oxidized | 15:32.5:52.5 | 2.2 | 47.5 | ⊚ | ◯ | ⊚ |
| example 13 | acetylated starch 1 | | | | | | |
| Reference | Oxidized | 15:32.5:52.5 | 2.2 | 47.5 | ⊚ | ◯ | ⊚ |
| example 14 | acetylated starch 2 | | | | | | |

As described above, according to the embodiment, satisfactory results were obtained in respect of all of: wrinkle resistance, tackiness, transparency (storability), and stringiness. Particularly obtained were satisfactory wrinkle resistance (property that prevents wrinkles from forming) and low stringiness, which means less stickiness during use. The viscosity of the liquid glue of each of Examples and Reference Examples shown in Tables 4 to 9 was approximately within the viscosity ranges for the Examples shown in Table 2.

According to the results shown on right-end portion of Table 4 above, it was confirmed that the liquid glues had satisfactory gelation resistance. According to the results in Tables 3 to 7 above, satisfactory results were obtained in all of: wrinkle resistance, tackiness and stringiness; when the weight ratio of sucrose to hydroxypropylated starch (SU/HPS) is in a range of 0.50 to 11.0 and the solid content is in a range of 40 to 70 wt %.

In particular, when the results of the Reference examples shown in Table 7 are referred to, it was considered that: the upper limit of the solids content would be about 70 wt %; and the lower limit would be about 40 wt % or 35 wt %, although these would be somewhat varied depending on the conditions. It was also considered that the upper and lower limits for the weight ratio of sucrose to hydroxypropylated starch (SU/HPS) would respectively be about 0.50 and about 11 when the solids content was close to its lower limit. When the solids content is around 60 wt %, which is presumed to be optimal, it was thought that a slightly wider weight ratio (SU/HPS) would be adoptable.

According to the results in Table 8 above, when glucose, trehalose, galactooligosaccharide, and xylitol were used as low molecular weight saccharides, the satisfactory results were obtained in respect of wrinkle resistance, tackiness, and stringiness. Furthermore, as a result of several weeks of observation, the transparency (storability) was also satisfactory. According to results of preliminary experiments, it was estimated that the upper limit of the preferred range of solids content would be less than 70 wt %.

According to the results of Examples 32 to 33 shown in Table 9 above, even when tapioca maltodextrin was used instead of hydroxypropylated starch, satisfactory results were obtained in respect of all of: wrinkle properties, tack properties, and stringiness. Here, the weight ratio of sucrose to “processed starch” (SU/HPS) and the solid content were set to be in presumably optimal ranges.

According to the results of Examples 34 to 36 shown in Table 9 above, even when “Hydroxypropylated Starch 2” with a smaller average degree of polymerization (for example, weight-average degree of polymerization) was used as the hydroxypropylated starch, satisfactory results were obtained. On the other hand, according to the results of Reference Examples 13 and 14 shown in Table 9 above, almost satisfactory results were obtained as well, even when a common one of oxidized acetylated starch was used.

1. A liquid glue for paper, in which a solid content is 40 to 70% by weight, wherein: the solid content is substantially composed of a water-soluble modified polysaccharide and a low molecular saccharide; a weight ratio of the low molecular saccharide to the modified polysaccharide ([weight of low molecular saccharide]÷[weight of modified polysaccharide]) is 0.4 to 12; a viscosity (BL type viscometer, 6 rpm) of the liquid glue is 500 to 10,000 mPa/s; and when the water-soluble modified polysaccharide is dextrin, its content is lower than the content of the low molecular saccharide.

2. The liquid glue for paper according to claim 1, wherein the water-soluble modified polysaccharide has a molecular weight exceeding 1000 and is at least one of: a starch derivative, a cellulose derivative, and a dextrin.

3. The liquid glue for paper according to claim 2, wherein the water-soluble modified polysaccharide is at least one of: hydroxyalkylated starch, oxidized starch, oxidized acetylated starch, methylated starch, carboxymethylated starch, acetylated starch, as the starch derivative; and methylated cellulose, hydroxyalkylated cellulose, carboxymethylated cellulose, as the cellulose derivative; and dextrin.

4. The liquid glue for paper according to claim 3, wherein the water-soluble modified polysaccharide is at least one of: hydroxyalkylated starch, oxidized starch, methylated starch, oxidized acetylated starch, and dextrin, where hydroxyalkylation of the hydroxyalkylated starch is hydroxypropylation or hydroxyethylation.

5. The liquid glue for paper according to claim 1, wherein the low molecular weight saccharide has a molecular weight of less than 1000 and is at least one of: monosaccharides, disaccharides, saccharide alcohols of these saccarides, and oligosaccharides.

6. The liquid glue for paper according to claim 5, wherein the low molecular saccharide is at least one of: sucrose, fructose, glucose, xylose, maltose, trehalose, xylitol, sorbitol, lactose, raffinose, maltotriose, galactooligosaccharide, fructooligosaccharide, and lactosucrose.

7. The liquid glue for paper according to claim 5, which is composed of an aqueous solution containing: 4 to 45% by weight of the water-soluble modified polysaccharide; 15 to 60% by weight of the low molecular saccharide; and 30 to 65% by weight of water.

8. The liquid glue for paper according to claim 3, wherein the water-soluble modified polysaccharide comprises a hydroxyalkylated starch, which has a molar substitution degree (MS) in a range of 0.04 to 0.4.
